(19) United States
(12) Patent Application Publication
(10) Pub. No.: US 2026/0079000 A1
(43) Pub. Date: Mar. 19, 2026

(54) OPTICAL MEASUREMENT DEVICE

(71) Applicant: LMI TECHNOLOGIES INC., Burnaby (CA)

(72) Inventor: Heimo KERÄNEN, Oulu (FI)

(21) Appl. No.: 19/133,632

(22) PCT Filed: Jun. 22, 2023
(86) PCT No.: PCT/FI2023/050383

§ 371 Date: May 28, 2025

(51) Int. Cl. G01B 11/02; G01B 11/06; G01B 11/30; G02B 5/18; G02B 5/28

(52) U.S. Cl. CPC G01B 11/026; G01B 11/06; G01B 11/30; G02B 5/18; G02B 5/28

(57) ABSTRACT

The invention relates to the field of optical measurement devices, in particular to displacement sensors, 3D sensors for measuring the position and/or shape or thickness of a measurement object or roughness sensors for measuring the roughness of the surface of an object. Measurement light is projected onto a measurement object after filtering by a first Fabry-Perot filter such that at each point in a measurement plane, the filtered measurement light has a locally unique wavelength or combination of wavelengths in at least one direction in the measurement plane. Measurement light reflected from the surface of the measurement object is filtered by a second Fabry-Perot filter in order to filter out measurement light not reflected from the intersection of the measurement object with the measurement plane.

### RELATED APPLICATIONS

This application is a national stage under 35 U.S. C. § 371 of International Application No. PCT/FI2023/050383, filed Jun. 22, 2023, which is hereby incorporated by reference in its entirety.

### TECHNICAL FIELD

The invention relates to the field of optical measurement devices, in particular to displacement sensors, 3D sensors for measuring the position and/or shape or thickness of a measurement object or roughness sensors for measuring the roughness of the surface of an object.

### BACKGROUND

In many displacement and 3D profile sensors known in the art, light is projected onto a measurement object and light reflected from the surface of the measurement object is measured in order to determine the shape of the object. The angle of incidence of light on the image sensor in many such devices is offset from zero. Image sensors, such as CCDs and APSs, are not designed to operate at such angles and their performance deteriorates as a result. In triangulation-based devices, the angle of incidence can be reduced by increasing the triangulation angle; however, this strategy is limited by the physical constraints of the system, e.g. it is not possible to increase the triangulation angle to 90 degrees as the sensor would occupy the same space as the measurement object. Furthermore, increasing the triangulation angle also has the undesirable side effect of increasing shadowing of the reflected light due to changes in the height of the measurement object. The greater the triangulation angle, the lower the change in height that cause shadowing. Furthermore, magnification leading to enlargement of the image causes further rotation of the intermediate image plane, further increasing the angle of incidence of light upon an image sensor if placed on the intermediate image plane, essentially preventing the use of such magnification which may otherwise be useful for improving accuracy of the sensor.

### SUMMARY

A first aspect of the invention relates to a sensor for measuring the displacement of the surface of a measurement object relative to the sensor. The sensor comprises:
a light source configured to emit measurement light;
a first Fabry-Pérot filter configured to filter the measurement light such that all mutually parallel light exiting the filter has the same wavelength or combination of wavelengths;
first optics configured to focus the filtered measurement light in a measurement plane, wherein at each point in the measurement plane the filtered measurement light has a locally unique wavelength or combination of wavelengths in at least one direction in the measurement plane;
second optics configured to receive filtered measurement light reflected from the surface a measurement object and to focus measurement light reflected from the measurement plane at infinity;
a second Fabry-Pérot filter configured to filter out measurement light not reflected from the measurement plane;
a sensor lens configured to focus measurement light filtered by the second Fabry-Pérot filter in a sensor plane; and
a light sensor positioned in the sensor plane and configured to measure light filtered by the second Fabry-Pérot filter.

An illumination axis extends from the light source to the measurement plane and a measurement axis extends from the measurement plane to the light sensor. The first Fabry-Pérot filter may be positioned relative to the illumination axis at a first Fabry-Pérot filter tilt angle defined between the illumination axis and a normal vector of the first Fabry-Pérot filter, and the second Fabry-Pérot filter may be positioned relative to the measurement axis at a second Fabry-Pérot filter tilt angle defined between the measurement axis and a normal vector of the second Fabry-Pérot filter.

The first Fabry-Pérot filter angle may be a non-zero angle.

The second Fabry-Pérot filter angle may be a non-zero angle.

The direction of rotation of the first Fabry-Pérot filter tilt angle may be opposite to the direction of rotation of the second Fabry-Pérot filter tilt angle. In this arrangement, the first optics and second optics may be mirror symmetric about a plane of symmetry parallel to and aligned with the measurement plane, and the first Fabry-Pérot filter angle and second Fabry-Pérot filter may have the same magnitude.

The direction of rotation of the first Fabry-Pérot filter tilt angle may be the same as the direction of rotation of the second Fabry-Pérot filter tilt angle. In this arrangement, the first optics and second optics may be mirror symmetric about a plane of symmetry normal to the measurement plane, and the first Fabry-Pérot filter angle and second Fabry-Pérot filter may have the same magnitude.

The separation between internal reflective surfaces and refractive indices of the layers of the first Fabry-Pérot filter may be the same as the separation between internal reflective surfaces and refractive indices of the layers of second Fabry-Pérot filter.

When the sensor is in use, measurement light incident on the light sensor may have locally unique wavelengths or combinations of wavelengths in at least one direction in the sensor plane. The term “locally unique” means that the wavelength or combination of wavelengths of measurement light at each point along at least one axis that lies in a plane is different to the wavelength or combination of wavelengths of measurement light incident of light at all other points along that axis.

The light sensor may be physically or logically divided into a plurality of regions, and each region may be sensitive to a single wavelength or single combination of wavelengths of measurement light. The regions of the light sensor may be individual pixels or groups of pixels.

The light source may be a diffuse polychromatic light source.

The light source and first Fabry-Pérot filter may be configured such that light is incident across the surface of the first Fabry-Pérot filter with a range of angles and wavelengths.

A light source lens may be used in association with the light source to modify the angles of incidence of the measurement light on the surface of the first Fabry-Pérot filter such that measurement light incident at each point in the illumination area of the first Fabry-Pérot filter is incident at a range of angles.

The light source may be an area light source that emits light across its surface at a range of angles. Alternatively, the light source may comprise a series of parallel light emitting lines such that measurement light is incident on the surface of the first Fabry-Pérot filter in a series of parallel lines, each line emitting at a range of angles.

In one arrangement, the first optics may comprise a first lens and the second optics comprises a second lens. A lens in this context may be a singlet lens or a compound lens. The focal planes of the first lens and second lens are co-planar and overlap within the measurement plane.

The first lens may be tilted relative to the illumination axis by a first lens angle such that the focal plane of the first lens is tilted relative to the illumination axis by the first lens angle, and the second may be tilted relative to the measurement axis by a second lens angle such that the focal plane of the second lens is tilted relative to the measurement axis by the second lens angle.

The first lens angle is defined by the angle between the optical axis of the first lens and the illumination axis, and the second lens angle is defined by the angle between the optical axis of the second lens and the measurement axis.

The first lens angle may be equal to the second lens angle.

The first lens and second lens may be arranged with mirror symmetry about the measurement plane.

In another arrangement, the first optics may comprise first illumination optics configured to focus filtered measurement light in a first focal plane, an illumination diffraction grating aligned with the first focal plane such that filtered measurement light is in focus across the illumination diffraction grating, and second illumination optics configured to focus measurement light diffracted by the illumination diffraction grating in the measurement plane. The second optics may comprise first measurement optics configured to focus measurement light reflected from the measurement plane in a first image plane, a measurement diffraction grating aligned with the first image plane such that reflected measurement light is in focus across the measurement diffraction grating, and second measurement optics configured to focus measurement light diffracted by the measurement diffraction grating at infinity.

The mean angle of incidence of measurement light on the illumination diffraction grating may be essentially zero, and the mean angle of diffraction of light from the measurement diffraction grating may be essentially zero. The term “essentially zero” means the magnitude of the angle is less than 5 degrees.

In any of the arrangements discussed above, the illumination axis and measurement axis may be on opposite sides of the measurement plane.

Alternatively, the illumination axis and measurement axis may be on the same side of the measurement plane.

The angle between the illumination axis and measurement plane may be greater than 45 degrees, less than 35 degrees, less than 25 degrees, or less than 15 degrees.

The angle between the measurement axis and measurement plane may be greater than 45 degrees, less than 35 degrees, less than 25 degrees, or less than 15 degrees.

The angle between the illumination axis and measurement plane may be the same as the angle between the measurement axis and measurement plane.

The angle between the measurement axis and the measurement plane is 90 degrees.

In a further arrangement, the first optics may comprise first illumination optics configured to focus filtered measurement light in a first focal plane, an illumination diffraction grating aligned with the first focal plane such that filtered measurement light is in focus across the illumination diffraction grating, and second illumination optics configured to focus measurement light diffracted by the illumination diffraction grating in the measurement plane. The second optics may comprise a second lens, i.e. a singlet or compound lens, and the focal plane of the second lens is co-planar with and overlaps the measurement plane.

A second aspect of the invention relates to a sensor apparatus for measuring the shape of the surface of a measurement object. The sensor apparatus comprises the sensor as described above, a stage for holding the measurement object, and a movement mechanism configured to move the sensor relative to the stage along a first movement vector, or the stage relative to the sensor along the first movement vector. The measurement plane is offset from the first movement vector by a measurement plane offset angle.

The measurement plane offset angle may be five degrees or less, six degrees or less, seven degrees or less, eight degrees or less, nine degrees or less, or ten degrees or less.

The stage may be a conveyor belt and the movement mechanism may be a conveyor mechanism.

A third aspect of the invention relates to a method. The method comprises positioning the measurement object at a first position relative to the sensor described above such that the surface of the measurement object intersects the measurement plane, and measuring the intensity of light received by the light sensor.

The method may further comprise repositioning the measurement object from the first position to a second position relative to the sensor, the change in position of the measurement object being defined by a first displacement vector, and measuring the intensity of light received by the light sensor.

The method may further comprise determining the displacement of a first set of one or more points on the surface of the measurement object by identifying the position of one or more intensity peaks of light measured by the light sensor when the measurement object is at the first position.

The method may further comprise determining the displacement of a second set of one or more points on the surface of the measurement object by identifying the position of one or more intensity peaks of light measured by the light sensor when the measurement object is at the second position.

The method may further comprise combining the displacement of the first set of one or more points with the displacement of the second set of one or more points and the first displacement vector to generate a three-dimensional model of the measurement object.

The method may further comprise determining the thickness of a transparent layer of the measurement object by calculating the distance between at least two distinct intensity peaks of light on the light sensor.

A fourth aspect of the invention relates to use of the sensor described above for measuring the displacement of the surface of a measurement object relative to the sensor, measuring the profile of the measurement object, measuring the three-dimensional shape of the measurement object, and/or measuring a thickness of a transparent layer of the measurement object.

### BRIEF DESCRIPTION OF THE DRAWINGS

FIG. 1 is a schematic drawing of a first optical sensor.

FIG. 2 is a schematic drawing of a second optical sensor.

FIG. 3 is a schematic drawing of a third optical sensor.

FIG. 4 is a schematic drawing of a fourth optical sensor.

### DETAILED DESCRIPTION

The invention relates to devices, systems and methods for measuring the displacement of an object relative to a sensor, or for measuring the roughness of the surface of an object. Both types of sensors employ the same basic principle measurement light is filtered using a Fabry-Pérot filter before being projected onto the measurement object such that at each point in a measurement plane that intersects the measurement object the measurement light has a locally unique wavelength or combination of wavelengths in the direction of the distance measurement. Measurement light reflected from the surface of the object is then filtered by a second Fabry-Pérot filter in order to filter out measurement light not reflected from the measurement plane. The basic principle of using the Fabry-Pérot filters as described above is the same across all embodiments on the invention.

In this context, “filter out” or “attenuate” does not mean the complete removal of measurement light reflected from outside the measurement plane, simply that the intensity of this light is reduced. As explained below, a high-finesse Fabry-Pérot filter more effectively filters out measurement light that is not reflected from the measurement plane, which may lead to a more accurate measurement, but the invention still functions even with a relatively low finesse Fabry-Pérot filter or filters.

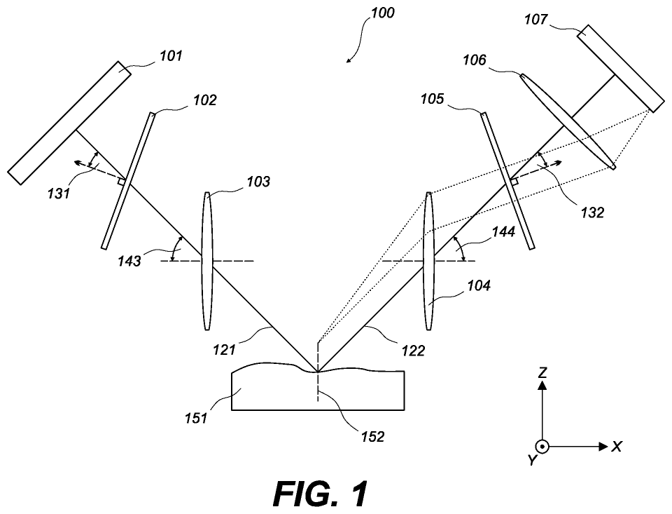

The sensor 100 of FIG. 1 includes a light source 101, which is configured to emit polychromatic measurement light. The emitted measurement light may have a relatively narrow bandwidth, or may emit light across a broad spectrum. While the term “measurement light” is used throughout this description, it should be understood that the device is not limited to electromagnetic radiation in the visible wavelength range, but may also or alternatively include infrared, ultraviolet or other wavelengths depending on the specific application.

Measurement light emitted by the light source 101 is incident on a first Fabry-Pérot filter 102 at a range of angles of incidence. The light source 101 is preferably a diffuse area light source, which emits light at a range of angles from each point on its surface. In this way, where measurement light is incident on the first Fabry-Pérot filter 102 it is incident with a range of angles. Light source 101 may be a single light source or multiple light sources. Light source 101 may emit light across the whole area or may include a series of parallel light emitting lines.

In this context, the term “Fabry-Pérot filter” preferably refers to an etalon with a fixed distance between its reflectors, although other types of Fabry-Pérot filters such as tuneable interference filters or interferometers with a tuneable distance between the reflectors may also be used. The wavelengths of light transmitted by a Fabry-Pérot filter are defined by the distance between reflectors l, the refractive index of the material between the reflectors n and the angle of incidence of light on the Fabry-Pérot filter θ. Transmission peaks occur when the optical path length of light reflected between the reflectors 2 n l cos α is an integer multiple of wavelength λ of the incident light. Therefore, for a fixed refractive index n and distance between reflectors l the wavelengths of light transmitted by a Fabry-Pérot interferometer depend on the angle of incidence α of light within the Fabry-Pérot filter, i.e. the angle relative to the surface of the reflectors. Therefore, where measurement light is incident on the first Fabry-Pérot filter 102, it is incident with a range of wavelengths such that some of the light incident on the first Fabry-Pérot filter 102 at different angles is not filtered out by the first Fabry-Pérot filter 102.

Since the angle of incidence of measurement light on the Fabry-Pérot filter and angle of emergence of filtered light are essentially identical, any given angle of incidence onto the Fabry-Pérot filter 102 will exit the filter as mutually parallel light having a common wavelength or combination of wavelengths.

As shown in FIG. 1, the normal vector of the first Fabry-Pérot filter 102 is offset by an angle 131 from an illumination axis 121 which extends from the light source 101 to the measurement plane 152.

The tilt of the first Fabry-Pérot filter 102 may be defined according to an axis-angle representation, where the axis of rotation is defined by a unit vector, the direction of rotation of the first Fabry-Pérot filter is indicated by the sign of the unit vector (i.e. positive or negative) following the right-hand rule, and the magnitude of the rotation is indicated by an angle. Using this definition, the tilt angle 131 may be described by a unit vector extending parallel to the Y-axis. The angle is measured between the illumination axis 121 and the normal vector of the Fabry-Pérot filter 102, i.e. the angle 131 as depicted in FIG. 1.

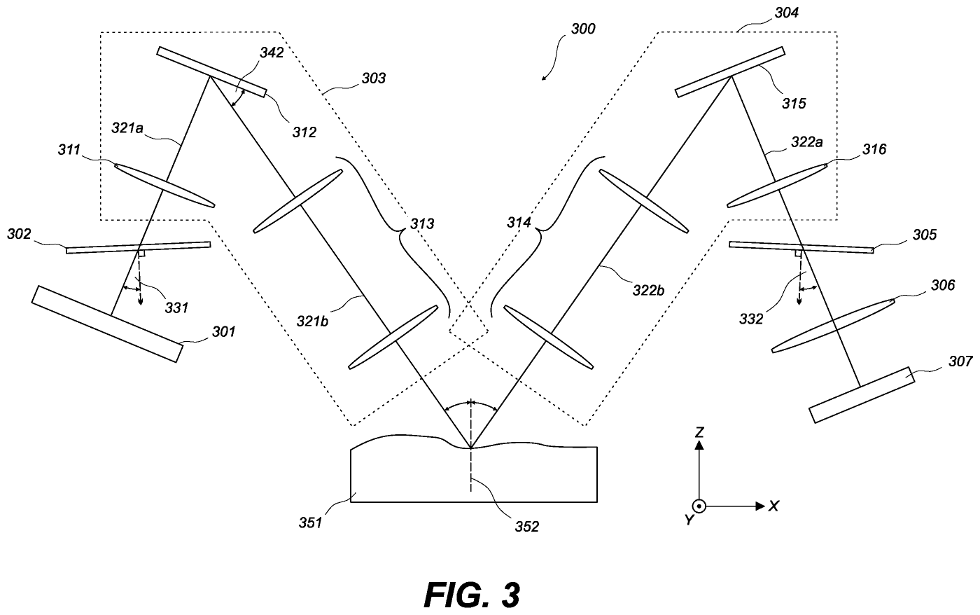

It is a feature of a Fabry-Pérot filter that the light exiting the filter consists of light at various angles but wherein each angle comprises a common wavelength or combination of wavelengths that is distinct from those exiting the filter at other angles. The filtered light is focused through first optics 103 into a measurement plane 152. In the embodiment of FIG. 1, the first optics 103 is depicted as a singlet lens, but in practice may be a compound lens or, as depicted in FIG. 3 for example, compound optics 303 comprising optical elements other than lenses. For the avoidance of doubt, where the term “lens” is used in this disclosure, it is intended to mean a singlet lens or a compound lens unless otherwise explicitly stated. In all cases, the functionality of the first optics is the same: to focus light filtered by the first Fabry-Pérot filter onto the measurement plane. Since all parallel light is focused at the same point in the focal plane of the first optics, i.e. the measurement plane 152, and all parallel light has the same wavelength or combination of wavelengths due to filtering by the Fabry-Pérot filter, all light focused at a given point in the measurement plane 152 has the same wavelength or combination of wavelengths. The different emission or exit angles from the filter result in a plurality of non-overlapping focussed points in the measurement plane, each focus point being characterized by a different wavelength or combination of wavelengths.

Measurement light filtered by the first Fabry-Pérot filter 102 and focused by first optics 103 is reflected from the surface of a measurement object 151. The intensity of the reflected light is greatest at points where the surface of the measurement object 151 intersects the measurement plane 152, i.e. where the measurement light is in focus on the surface of the measurement object 151. Measurement light is typically scattered, i.e. diffusely reflected, from the surface of the measurement object 151. Some of this reflected measurement light enters second optics 104, which, like the first optics 103, is positioned such that its focal plane is aligned with the measurement plane 152. As a result, measurement light reflected from the measurement plane 152 is focused at infinity by the second optics 104. In other words, rays of light reflected from a given point on the measurement plane 152 propagate parallel to one another after passing through the second lens 104. In the embodiment of FIG. 1, the second optics 104 is a lens, but as depicted in FIG. 3, for example, the second optics 104 may alternatively be compound optics. In all cases, the functionality of the second optics is the same: to focus light reflected from the measurement object at its intersection with the measurement plane at infinity such that all rays of light received by the second optics from a single point in the measurement plane propagate in parallel after emerging from the second optics.

This reflected measurement light, focused at infinity by the second optics 104, is incident on a second Fabry-Pérot filter 105. The second Fabry-Pérot filter 105 is configured to filter out measurement light not reflected from the measurement plane. Since all light focused at a given point in the measurement plane 152 has the same wavelength or combination of wavelengths, light rays reflected from a given point in the measurement plane 152 propagate in parallel from the second optics 104 and have the same wavelength or combination of wavelengths. Thus, light reflected from the measurement plane 152 that is incident on the second Fabry-Pérot filter 105 at a given angle of incidence has the same wavelength or combination of wavelengths and may pass through the second Fabry-Pérot filter, while light reflected from other parts of the measurement object 151 that do not intersect the measurement plane 152 generally does not have the same wavelength and do not pass through the second Fabry-Pérot filter 105. Filtering of the reflected measurement light by the second Fabry-Pérot filter 105 may be achieved by selecting an appropriate tilt angle 132 for the second Fabry-Pérot filter 105. Following the same axis-angle representation of the tilt angle used above for tilt angle 131 of the first Fabry-Pérot filter 102, the tilt angle 131 may be described by a unit vector extending parallel to the Y-axis. The angle is measured between the measurement axis 122 and the normal vector of the second Fabry-Pérot filter 105, i.e. the angle 132 as depicted in FIG. 1.

This arrangement is particularly effective when the wavelength or combination of wavelengths of light in focus at each point in the measurement plane is locally unique in at least one direction in the measurement plane. In other words, the wavelength or combination of wavelengths of light in focus at each point in the measurement plane is unique amongst points that lie along at least one axis that lies within the measurement plane. Preferably this axis is parallel to the z-axis shown in the drawings. The performance of the optical sensor 100 for measuring the height of the measurement object 152, i.e. the position on the z-axis at each y-coordinate, is improved when the wavelength or combination of wavelengths of light in focus at each point in the measurement plane 152 is unique amongst points with the same y-coordinate. Thus, it is preferable for the angle 131 of the first Fabry Pérot filter 102 relative to the illumination axis 131 to be set such that at each point in the measurement plane, the wavelength or the combination of wavelengths of light in focus is unique amongst points with the same y-coordinate.

As described above, the first Fabry-Pérot filter 102 is preferably tilted relative to the illumination axis 121 by rotating the Fabry-Pérot filter about an axis parallel to the measurement plane and perpendicular to the illumination axis 121. In the drawing of FIG. 1, this is the Y-axis. In the embodiment depicted in FIG. 1, this means that the axis of rotation of the first Fabry-Pérot filter 102 and the axis of rotation of the first lens 103 are parallel. The offset angle 131 is measured in the Z-X plane, as shown in FIG. 1.

The input angles, i.e. angles of incidence, of light on the first Fabry-Pérot filter 102 may also be restricted to only positive or only negative angles to avoid the transmission of light of the same wavelength or combination of wavelengths at two different input angles.

Reflected filtered measurement light that exits the second Fabry-Pérot filter is incident on a sensor lens 106, which focuses light received from the second Fabry-Pérot filter in a sensor plane, i.e. in the focal plane of the sensor lens 106. Again, since the angle of incidence on the Fabry-Pérot filter and the angle of emergence of light that passes through the second Fabry-Pérot filter are the same, rays of reflected measurement light from a single point on the measurement plane 152 have the same wavelength or combination of wavelengths and propagate towards the sensor lens 106 in parallel and are focused on a single point in the sensor plane. The same applies to reflections from other points in the measurement plane but at other wavelengths or combinations of wavelengths.

An image sensor 107 is positioned in the sensor plane such that its active surface is aligned with the sensor plane and reflected filtered measurement light is in focus on the active surface of the image sensor. Image sensor 107 may be a CCD (charge-coupled device), CMOS (Complementary metal-oxide-semiconductor) or other APS (active pixel sensor), or a line scan camera.

By measuring the intensity of light received at each point (e.g. each pixel) on the image sensor, the displacement or shape of the measurement object 151 at its intersection with the measurement plane 152 can be determined.

The image sensor may be physically or logically divided into a plurality of regions, e.g. individual pixels or groups of pixel, each of which is sensitive only to a single wavelength or combination of wavelengths, or a narrow range of wavelengths or combinations of wavelengths.

The use of the first and second Fabry-Pérot filters 102 and 105 to filter measurement light and light reflected from the measurement plane 152 produces a very clean and narrow image on the image sensor 107, which results in a more accurate measurement of the profile of the measurement object 151. The position of this line in the sensor 107 depends on the location of the intersection of the surface of the measurement object 151 with the measurement plane 152.

As shown in FIG. 1, the optical axis of the lens of first optics 103 is offset by an angle 143 from an illumination axis 121 which extends from the light source 101 to the measurement plane 152. As a result, the measurement plane 152, which is defined by the overlapping focal planes of the first optics 103 and second optics 104, is also tilted relative to the illumination axis 121. The optical axis of the lens of second optics 104 is also offset from the measurement axis 122, which extends from the measurement plane to the image sensor, by an angle 144. Where lenses with the same focal length are used in the first optics 103 and second optics 104, the angle 143 is equal to angle 144. The tilt angle of the lens 103 also tilts the angle of the focal plane of the lens 103 that is the measurement plane 152. The tilt angles of the lenses 103 and 104 are aligned so that their focal planes coincide with each other.

In order to tune the first and second Fabry-Pérot filter 102, 105 such that measurement light reflected from the measurement plane 152 can pass through the second Fabry-Pérot filter 105, the angle 131 of the first Fabry-Pérot filter relative to the illumination axis 121 may be adjusted, or the angle 132 of the second Fabry-Pérot filter relative to the measurement axis 122 may be adjusted, or both angles 131 and 132 may be adjusted. Alternatively, where a Fabry-Pérot interferometer or interference filter with a tuneable distance between reflectors is used, this may be used to ensure the correct performance of the device in addition to or instead of adjusting the relative angles of the Fabry-Pérot filters. The use of an etalon or other Fabry-Pérot filter with a fixed distance between internal reflective surfaces is preferable so that the tuning needs to be performed only once, typically in the manufacturing process. As an example, angular tuning of one or both Fabry-Pérot filters 102, 105 may be achieved by screws which adjust the angle of the Fabry-Pérot filter.

The ability to tune the device by adjusting the angles and/or distance between reflectors enables a simpler, less demanding manufacturing process, as small imperfections can be corrected after the device has been manufactured.

The reflectivity of the reflective surfaces within a Fabry-Pérot filter determines the width of transmission peaks of the Fabry-Pérot filter in the frequency (or wavelength) domain. A Fabry-Pérot filter with narrow transmission peaks, i.e. a high Q-factor, is said to have high finesse. The use of high finesse Fabry-Pérot filters improves the accuracy of the sensor of the present invention since filtering of the measurement light reflected from outside the measurement plane by the second Fabry-Pérot filter 105 is improved, leading to a narrower intensity peak on the sensor 107. However, narrower transmission peaks of the Fabry-Pérot filters 102, 105 demands more accurate alignment of the first and second Fabry-Pérot filter 102, 105 to ensure overlap of the desirable transmission peaks. Thus, the ability to precisely tune the angles of the Fabry-Pérot filters 102, 105, as mentioned above, also allows for high finesse Fabry-Pérot filters to be used.

In the embodiment depicted in FIG. 1, the first Fabry-Pérot filter 102, first optics 103, second optics 104 and second Fabry-Pérot filter 105 are arranged with mirror symmetry about the measurement plane 152. In this case, the focal lengths of the first optics 103 and second optics 104 are the same, and the distance between reflectors and refractive index of material between the reflectors in the first Fabry-Pérot filter 102 and second Fabry-Pérot filter 105 are the same. The magnitude of the tilt angles 131, 132 of the first and second Fabry-Pérot filters 102, 105 are also the same, but the direction of rotation is opposite, i.e. one of the Fabry-Pérot filters 102, 105 is rotated clockwise and the other is rotated anti-clockwise.

It will be appreciated that exact mirror symmetry of the illumination and measurement optics is not required even when the first optics 103 has the same optical properties as the second optics 104 and the first Fabry-Pérot filter 102 has the the same optical properties as the second Fabry-Pérot filter 105. In particular, the position of each Fabry-Pérot filter 102, 105 along the respective illumination or measurement axis can be adjusted without changing the angle of incidence or emergence of measurement light. Thus, the positions of the Fabry-Pérot filter 102, 105 do not need to be identical, as long as the tilt angles 131 and 132 have the same magnitude.

The device 100 may optionally include a further lens positioned between the light source 101 and the first Fabry-Pérot filter 102 in order to ensure that light is incident on the first Fabry-Pérot filter 102 at a range of angles across its surface. This may enable a smaller or less diffuse light source to be used, e.g. by placing the light source out of the focal plane of the further lens. If the light source is smaller the angle range of the light source to the collecting lens must be larger in order to get the same angle and power distribution in the first Fabry-Pérot filter 102.

The bandwidth of the light source 101 may be restricted to ensure local uniqueness of the wavelengths or combination of wavelengths in focus in the measurement plane and/or the sensor plane based on the offset (tilt) angle of the first Fabry-Pérot filter 102 and the input angle range of the Fabry-Pérot filter 102.

Restriction of the light source bandwidth may be achieved by using a suitable narrowband light source, such as an LED, or by additionally filtering the light emitted from a broadband light source 101 before it is incident in the measurement plane 152.

Alternatively, where a broadband light source is used, the measurement light may be filtered to an appropriate range of wavelengths at any point between the light source 101 and the sensor 107 in order to ensure local uniqueness of the wavelengths or combination of wavelengths in focus in the sensor plane.

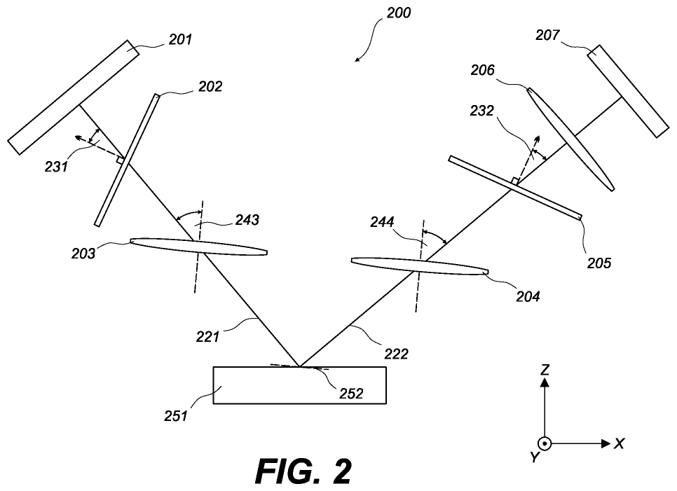

FIG. 2 depicts a second optical sensor 200, which operates in essentially the same manner as described above with respect to the displacement sensor 100 of FIG. 1. Equivalent features of both devices are denoted by similar reference numerals, e.g. 101 and 201 both indicate the light source as described above.

The sensor 200 differs from displacement sensor 100 in that the illumination axis 221 and measurement axis 222 lie on the same side of the measurement plane 252. In the embodiment of FIG. 2, in which the first optics 203 and second optics 203 are both tilted lenses, the tilt of each lens with respect to the illumination axis 221 or measurement axis 222 is in the opposite direction to the tilt of the corresponding lenses in the displacement sensor 100.

To accommodate for the presence of both the illumination and measurement axes on the same side of the measurement plane 252, one of the offset angles 231 and 232 of the Fabry-Pérot filters 202 and 205 is flipped about the illumination axis 221 or measurement axis 222 respectively compared to the corresponding angles 131, 132 in the sensor 100. In other words, the direction of rotation of both Fabry-Pérot filters 202, 205 is the same in the sensor 200, i.e. both are clockwise or both are anticlockwise as defined by the Y-axis in FIG. 2.

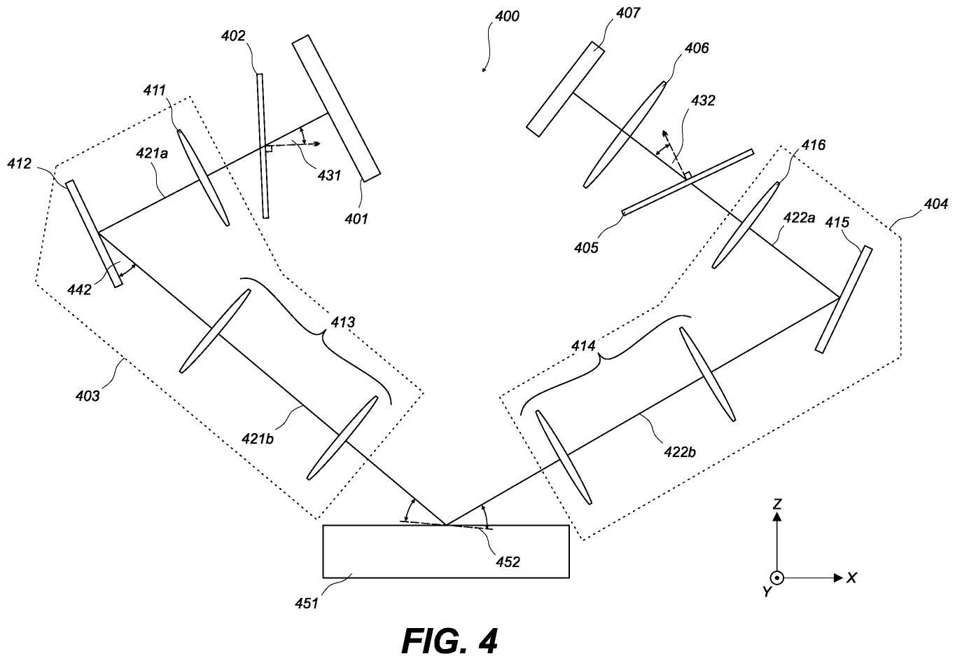

This inversion of the direction of the wavelength scale in the illumination and measurement parts of the sensor cannot be achieved in conventional confocal line sensors that use, for example, a prism or a grating. Thus, the use of Fabry-Pérot filters with opposite tilt angles in this manner enables the configuration depicted in FIG. 2 (and FIG. 4 described below).

Furthermore, the entire device 200 is tilted relative to the surface of the measurement object 251, such that the measurement plane 252 is tilted by a small angle, e.g. less than ten degrees, relative to the surface of the measurement object 251. Alternatively, the tilt of the device 200 may be defined relative to a stage for holding the measurement object, or relative to a movement vector along which the sensor and stage move relative to one another. In any situation, the result is that the measurement plane 252 is close to parallel to the surface of the measurement object 251, which means that relatively small changes in the height of the measurement object 251 produce large changes in the point of the measurement plane 252 that intersects with the surface of the measurement object. This produces larger changes in the location of maximum light intensity on the image sensor 207.

One of the advantages of this sensor configuration is that the illumination angle and the measurement angles, i.e. the angle between the illumination axis 221 and the measurement plane 252, and the angle between the measurement axis 222 and the measurement plane, can be very large so that the spatial separation of different wavelengths is very large compared to the change in height of the measurement object due to large triangulation angle effect. Even a very small difference in the height of the surface of the measurement object spatially separates each other light beams of the same wavelength of the receiver and the imager. This makes the lines in the receiver camera sharper than in the case where the illumination and measurement angles are smaller.

This sensor 200 can also be a very sensitive area 3D scanning sensor where the surface is scanned along the X-axis, as shown in FIG. 2, and where the correct three-dimensional coordinates are calculated by utilizing the already known X-coordinates of the measurement points corresponding the measured Z-coordinates. In this way the almost horizontal direction of the measurement plane can be still utilized to obtain accurate three-dimensional coordinates of the surface.

In an alternative embodiment to that depicted in FIG. 2, the illumination axis 221 may extend perpendicularly from the measurement plane 252, in which case the optical axis of the lens of first optics 203 is not offset from the illumination axis 221. In order to match the wavelengths or the combination of wavelengths of the illumination and imaging in the measurement plane to fit each other the magnifications of the optics or the properties of the Fabry-Pérot filter for the illumination and imaging is varied accordingly. Such an arrangement reduces the overall size of the sensor 200 and reduces the negative optical effects caused by tilting the lens 203 relative to the illumination axis 221. As a further alternative, the measurement axis 222 may extend perpendicularly from the measurement plane 252 instead of the illumination axis 221, in which case the optical axis of the lens of the second optics 204 is not offset from the measurement axis 222.

FIG. 3 depicts a third optical sensor 300 that corresponds to the optical displacement sensor 100 described above with respect to FIG. 1, but in which the first optics 303 and second optics 304 include multiple lenses and a diffraction grating.

In particular, the first optics 303 includes first illumination optics 311, an illumination diffraction grating 312, and second illumination optics 313. The first illumination optics 311 is configured to focus light filtered by the Fabry-Pérot filter 302 in a first focal plane. First illumination optics may be a single lens, compound lens, or any other optics suitable for performing this function. The illumination diffraction grating 312 is aligned with the first focal plane such that measurement light filtered by the first Fabry-Pérot filter 302 is in focus across the illumination diffraction grating. Second illumination optics 313 is configured to focus light diffracted by the illumination diffraction grating 312 in the measurement plane 352.

Since all mutually parallel light rays emerging from the first Fabry-Pérot filter 302 have the same wavelength of combination of wavelengths, all measurement light focused on each point in the first focal plane by first illumination optics 311 has the same wavelength or combination of wavelengths.

The surface of the illumination diffraction grating 312 is aligned with the first focal plane of the first illumination optics 311. The angle of diffraction θₘ of light from a diffraction grating is determined by the ruling or slit pitch d (also referred to as ruling or slit separation) of the diffraction grating, the wavelength λ of incident light and the angle of incidence θᵢ according to the grating equation d(sinθᵢ−sinθₘ)=±mλ, where m is the mode number m∈N={0, 1, 2, 3 . . . }. The angle of incidence θᵢ and angles of diffraction θₘ are defined in opposite directions relative to a plane parallel to the diffraction grating's rulings or slits and extending perpendicular to the planar surface of the diffraction grating, also referred to as the grating normal.

Filtered measurement light is diffracted from the surface of the diffraction grating 312 towards second illumination optics 313. Second illumination optics 313 focuses light diffracted from the surface of the illumination diffraction grating 312 in the measurement plane 352. In other words, for the optical system consisting of the illumination diffraction grating 312, second illumination optics 313 and the measurement plane 352, the illumination diffraction grating 312 lies in the subject plane, the lens plane is defined by the second illumination optics 313, and the measurement plane 352 lies in the image plane as defined by the Scheimpflug principle.

The angle 342 between the surface of the grating and the optical axis 321b extending from the illumination diffraction grating 312 to the measurement plane 352 is dictated by the diffraction of light from the diffraction grating. Preferably, the second illumination optics 313 is positioned to maximise the amount of diffracted light entering the second illumination optics 313 and therefore focused on the measurement plane 352. This is achieved when as many of the diffraction modes across the range of wavelengths and angles of incidence of light on the illumination diffraction grating 312 enter the second illumination optics 313 as possible. Thus, the angle 312 and the angle of the measurement plane 352 relative to the optical axis 321b can be adjusted by changing the wavelengths of light used for the measurement light emitted by light source 301 or by changing the properties of the diffraction grating such as the pitch of rulings or slits.

In FIG. 3, second illumination optics 313 is shown as a compound lens but may in fact be any suitable optics for performing the function of focusing light from the surface of the diffraction grating in the measurement plane.

In combination, first optics 303 of displacement sensor 300 performs the same function as the first optics 103 of the displacement sensor 100 and first optics 203 of the sensor 200: to focus measurement light filtered by the first Fabry-Pérot filter in a measurement plane which is tilted relative to the illumination axis 121, 221, 321a and 321b extending from the light source or first Fabry-Pérot filter to the measurement plane.

The use of a diffraction grating to change then angle of the measurement plane 352 relative to the illumination axis 321b provides a more precise distribution of wavelengths of measurement light across the measurement plane 352 than the tilting of a lens as shown in FIG. 1, which may exacerbate imperfections in the lens leading to blurring of the wavelengths in the measurement plane.

Second optics 304 of the displacement sensor 300 includes first measurement optics 314, a measurement diffraction grating 315, and second measurement optics 316. First measurement optics 314 is configured to focus measurement light reflected from the measurement plane 353 in a first image plane. The measurement diffraction grating 315 is aligned with the first image plane such that measurement light reflected from the measurement plane 352 and focused by the first measurement optics 314 is in focus across the surface of the measurement diffraction grating 315. Measurement light diffracted from the measurement diffraction grating 315 enters the second measurement optics 316, which is configured to focus the measurement light diffracted from the measurement diffraction grating 315 at infinity.

Similarly to the situation described above with respect to the first optics 304, in the optical system consisting of the measurement plane 352, the first measurement optics 314 and measurement diffraction grating 315, the measurement plane 352 lies in the subject plane, the lens plane is defined by the first measurement optics 314, and the measurement diffraction grating 315 lies in the image plane according to the Scheimpflug principle.

The second measurement optics 316 is configured to focus measurement light diffracted by the measurement diffraction grating 315 at infinity. The second measurement optics 316 is therefore positioned such that the focal plane of the lens is aligned with the surface of the diffraction grating, i.e. with the first image plane.

Again, it can be seen that in combination, second optics 304 of displacement sensor 300 performs the same function as the second optics 104 of the displacement sensor 100 and second optics 204 of the sensor 200: to focus measurement light reflected from the measurement plane at infinity.

While FIG. 3 depicts both the illumination diffraction grating 312 and the measurement diffraction grating 315 as reflective diffraction gratings, one or both may instead be transmissive diffraction gratings.

Preferably, the optical properties of the first illumination optics 311 are the same as the optical properties of the second measurement optics 316, the optical properties of the illumination diffraction grating 312 are the same as the optical properties of the measurement diffraction grating 315, and the optical properties of the second illumination optics 313 and the same as the optical properties of the first measurement optics 314. In this configuration, the first optics 303 and second optics 304 are arranged symmetrically about the measurement plane 352. Furthermore, the same component or components can be used to manufacture the first optics 303 and second optics 304, making the displacement sensor easier to manufacture and more accurate.

FIG. 4 depicts a fourth sensor 400, which uses the same compound optics for the first optics 403 and second optics 404 as the displacement sensor 300. Like the sensor 200, the illumination axis 421b and measurement axis 422b lie on the same side of the measurement plane 452. This can be achieved by rotating the first and second optics by 180 degrees about the illumination axis 421b and measurement axis 422b respectively compared to the displacement sensor 300. As explained above with respect to FIG. 2, the offset angles 431 and 432 of the Fabry Pérot filters 402 and 405 are of opposite sign so that the wavelength scales of the illumination and measurement parts of the sensor are inverted. Except for this rotation and the opposite tilt of the Fabry-Pérot filters, the configuration and advantages of the sensor 400 are the same as the displacement sensor 300. The sensor 400 functions in essentially the same way as described above with respect to the sensor 200.

Any of the displacement sensors described above may be used in a three-dimensional sensor for measuring the three-dimensional shape of the measurement object. By imaging the measurement light projected onto the measurement object at multiple positions on the measurement object, a three-dimensional model of the measurement object can be constructed. In practice, displacement measurements are repeatedly or continuously made as the measurement object moves through the measurement plane, which may be achieved either by moving the sensor relative to a stationary measurement object, or by moving the measurement object relative to the sensor, e.g. on a conveyor belt. Each measurement can be seen as measuring the profile of a cross-sectional slice of the measurement object, and the three-dimensional shape of the measurement object can be reconstructed from these profile measurements by combining them with the known displacement between each measurement.

The sensors may also be used also for multilayer measurement, for example for measuring thicknesses of transparent films. Reflection of the measurement light from the surface of each layer of the transparent film produces a distinguishable intensity peak, and when the refractive indices of the layers are known, the thickness can be calculated based on the distance between two subsequent peaks.

Furthermore, where the light sensor is an image sensor such as a CCD or APS, such as a CMOS sensor, the light sensors may also capture conventional 2D images of the surface of the measurement object while simultaneously measuring the displacement as described above.

1-43. (canceled)

44. A sensor for measuring the surface of a measurement object relative to the sensor, comprising:
a light source configured to emit measurement light;
a first Fabry-Pérot filter configured to filter the measurement light such that all mutually parallel light is of the same wavelength or combination of wavelengths;
first optics configured to focus measurement light exiting the first Fabry-Pérot filter onto a measurement plane, wherein the measurement light has a unique wavelength or combination of wavelengths at each point of focus of said measurement light along an axis in the measurement plane;
second optics configured to receive measurement light reflected from the surface of a measurement object and to direct said measurement light onto a second Fabry-Pérot filter;
a sensor lens configured to focus measurement light exiting the second Fabre-Pérot filter onto a sensor plane; and,
a light sensor in the sensor plane configured to measure measurement light exiting the second Fabry-Pérot filter.

45. The sensor of claim 44, wherein:
an illumination axis extends from the light source to the measurement plane;
a measurement axis extends from the measurement plane to the light sensor;
the first Fabry-Pérot filter is positioned relative to the illumination axis at a first Fabry-Pérot filter tilt angle defined between the illumination axis and a normal vector of the first Fabry-Pérot filter; and
the second Fabry-Pérot filter is positioned relative to the measurement axis at a second Fabry-Pérot filter tilt angle defined between the measurement axis and a normal vector of the second Fabry-Pérot filter.

46. The sensor of claim 45 wherein a direction of rotation of the first Fabry-Pérot filter tilt angle is opposite to a direction of rotation of the second Fabry-Pérot filter tilt angle.

47. The sensor of claim 45 wherein a direction of rotation of the first Fabry-Pérot filter tilt angle is the same as a direction of rotation of the second Fabry-Pérot filter tilt angle.

48. The sensor of claim 46 wherein the first optics and second optics are mirror symmetric about a plane of symmetry parallel to and aligned with the measurement plane, and wherein the first Fabry-Pérot filter angle and second Fabry-Pérot filter have the same magnitude.

49. The sensor of claim 44, wherein the separation between internal reflective surfaces and refractive indices of the layers of the first Fabry-Pérot filter are the same as the separation between internal reflective surfaces and refractive indices of the layers of second Fabry-Pérot filter.

50. The sensor of claim 44 wherein the light sensor is characterized by a plurality of regions, and wherein each region is sensitive to a single wavelength or single combination of wavelengths of measurement light.

51. The sensor of claim 44, wherein measurement light emitted from the light source illuminates the first Fabry-Pérot filter at a plurality of angles of incidence.

52. The sensor of claim 51 wherein the light source comprises a light source lens configured such that measurement light incident at each point in the illumination area of the first Fabry-Pérot filter is incident at a predetermined range of angles.

53. The sensor of claim 44 wherein measurement light is incident on the surface of the first Fabry-Pérot filter in a series of parallel lines.

54. The sensor of claim 44, wherein the first optics comprises:
first illumination optics configured to focus filtered measurement light in a first focal plane;
an illumination diffraction grating aligned with the first focal plane such that filtered measurement light is in focus across the illumination diffraction grating; and
second illumination optics configured to focus measurement light diffracted by the illumination diffraction grating in the measurement plane;
and wherein the second optics comprises:
first measurement optics configured to focus measurement light reflected from the measurement plane in a first image plane;
a measurement diffraction grating aligned with the first image plane such that reflected measurement light is in focus across the measurement diffraction grating; and
second measurement optics configured to focus measurement light diffracted by the measurement diffraction grating at infinity.

55. The sensor of claim 54, wherein a mean angle of incidence of measurement light on the illumination diffraction grating is less than 5 degrees, and wherein the mean angle of diffraction of light from the measurement diffraction grating is less than 5 degrees.

56. The sensor of claim 44, wherein:
an illumination axis extends from the light source to the measurement plane;
a measurement axis extends from the measurement plane to the light sensor; and
the illumination axis and measurement axis are on the same side of the measurement plane.

57. A sensor for measuring the shape of the surface of a measurement object, the sensor comprising:
the sensor of claim 44;
a stage for holding the measurement object; and
a movement mechanism configured to move the sensor relative to the stage along a first movement vector, or the stage relative to the sensor along the first movement vector;
wherein the measurement plane is offset from the first movement vector by a measurement plane offset angle.

58. Use of the sensor of claim 44 for measuring the displacement of the surface of a measurement object relative to the sensor, measuring the profile of the measurement object, measuring the three-dimensional shape of the measurement object, and/or measuring a thickness of a transparent layer of the measurement object.

59. A method for measuring the surface of a measurement object relative to a sensor, the method comprising:
emitting measurement light from a light source;
filtering the measurement light using a first Fabry-Pérot filter such that all mutually parallel light is of the same wavelength or combination of wavelengths;
focusing the filtered measurement light onto a measurement plane using first optics, wherein the measurement light has a unique wavelength or combination of wavelengths at each point of focus along an axis in the measurement plane;
receiving measurement light reflected from the surface of the measurement object using second optics and directing the reflected measurement light onto a second Fabry-Pérot filter;
filtering the reflected measurement light using the second Fabry-Pérot filter; focusing the filtered reflected measurement light onto a sensor plane using a sensor lens; and
measuring the filtered reflected measurement light at the sensor plane using a light sensor.

60. The method of claim 59, further comprising:
adjusting an angle of the first Fabry-Pérot filter relative to the illumination axis, or adjusting an angle of the second Fabry-Pérot filter relative to the
measurement axis, or adjusting both angles, to tune the first and second Fabry-Pérot filters such that measurement light reflected from the measurement plane can pass through the second Fabry-Pérot filter.

61. The method of claim 59, further comprising adjusting a distance between reflectors of at least one of said Fabry-Pérot filters such that measurement light reflected from the measurement plane can pass through an other of said Fabry-Pérot filters.

62. The sensor of claim 44, wherein the first Fabry-Pérot filter is configured to be adjustable relative to the illumination axis, the second Fabry-Pérot filter is configured to be adjustable relative to the measurement axis, or both, to tune the first and second Fabry-Pérot filters such that measurement light reflected from the measurement plane can pass through the second Fabry-Pérot filter.
